(19) United States
(12) Patent Application Publication
(10) Pub. No.: US 2025/0035909 A1
(43) Pub. Date: Jan. 30, 2025

(54) MICROSCOPE CONTROL ARRANGEMENT, MICROSCOPE SYSTEM, METHOD OF CONTROLLING A MICROSCOPE AND COMPUTER PROGRAM

(71) Applicant: Leica Microsystems CMS GmbH, Wetzlar (DE)

(72) Inventor: Dennis JAEHNERT, Wetzlar (DE)

(21) Appl. No.: 18/715,754

(22) PCT Filed: Dec. 6, 2021
(86) PCT No.: PCT/EP2021/084394

§ 371 Date: Jun. 3, 2024

(51) Int. Cl. G02B 21/36; G02B 21/00

(52) U.S. Cl. CPC G02B 21/365; G02B 21/0076

(57) ABSTRACT

A microscope control arrangement includes one or more processors, one or more storage devices, and a display device. The one or more processors are configured to render a graphical user interface on the display device. The graphical user interface includes control widgets configured to receive user inputs. The one or more processors are further configured to translate the user inputs to the control widgets into at least one of an illumination setting or a detection setting in dependence of a microscopy operation mode selected from of a plurality of microscopy operation modes.

### CROSS REFERENCE TO RELATED APPLICATIONS

This application is a U.S. National Phase application under 35 U.S.C. § 371 of International Application No. PCT/EP2021/084394, filed on Dec. 6, 2021. The International Application was published in English on Jun. 15, 2023 as WO 2023/104281 A1 under PCT Article 21 (2).

### FIELD

Embodiments of the present invention relate to a microscope control arrangement, to a microscope system, to a method of controlling a microscope and to a computer program.

### BACKGROUND

EP 3 721 279 B1 discloses, shown in FIG. 3, a microscope system comprising two detection units. By means of a switchable or displaceable mirror, light can be guided via corresponding beam paths into either one of these detection units. One of the detections units can be connected to, or be part of, a wide-field detection system, and one of the detection units can be connected to, or be part of, a confocal detection system. Wide-field and confocal illumination units corresponding to the detection units are also provided in an embodiment. That is, EP 3 721 279 B1 relates, in the embodiment discussed, to a microscope system in which a microscopy operation mode, i.e. a wide-field and a confocal operation mode, can be selected from of a plurality of, i.e. two, microscopy operation modes.

### SUMMARY

Embodiments of the present invention provide a microscope control arrangement. The microscope control arrangement includes one or more processor and one or more storage devices. The one or more processors are configured to render a graphical user interface. The graphical user interface includes control widgets configured to receive user inputs. The one or more processors are further configured to translate the user inputs to the control widgets into at least one of an illumination setting or a detection setting in dependence of a microscopy operation mode selected from of a plurality of microscopy operation modes.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a microscope system according to some embodiments;

FIG. 2 illustrates aspects of a microscope according to some embodiments;

FIG. 3 illustrates aspects of a graphical user interface according to some embodiments;

FIGS. 4a to 4e illustrate widget groups of a graphical user interface according to some embodiments;

FIG. 5 illustrates fluorescence control widgets according to some embodiments;

FIG. 6 illustrates a user input to fluorescence control widgets according to some embodiments;

FIG. 7 illustrates regrouping fluorescence control widgets according to some embodiments; and

FIG. 8 illustrates a further user input to fluorescence control widgets according to some embodiments.

### DETAILED DESCRIPTION

Embodiments of the present invention can improve the operation of microscope systems in which a microscopy operation mode can be selected from different operation modes, in particular in terms of effectiveness and user friendliness.

A microscope control arrangement comprising one or more processors and one or more storage devices is provided, wherein the microscope control arrangement is configured to render a graphical user interface and, as a part of the graphical user interface, control widgets configured to receive user inputs, and wherein the microscope control arrangement is configured to translate the user inputs to the control widgets into at least one of an illumination and a detection setting in dependence of a microscopy operation mode selected from of a plurality of microscopy operation modes. Such a microscope control arrangement has the advantage that, particularly with essentially the same widgets, a user may operate a microscope system in which a microscopy operation mode can be selected from of a plurality of microscopy operation modes in a more user-friendly manner and particularly is not required to have knowledge of the technical details of different operating concepts. In other words, using the instrumentalities as proposed herein, a unified operating concept may be provided for different microscopy operation modes.

The term “widget” shall, in the understanding used herein, refer to any element of interaction rendered as a part of a user interface including, but not limited to, elements configured for selection and for the display of elements or collections such as buttons (including radio buttons, check boxes, toggle switches, toggle buttons, split buttons, cycle buttons), sliders, list boxes, spinners, drop-down lists, menus (including context menus and pie menus), menu bars, tool bars (including ribbons), combo boxes, icons, tree views, grid views, elements configured for navigation such as links, tabs and scrollbars, elements for textual input such as text and combo boxes, elements for output of information such as labels, tool tips, help balloons, status bars, progress bars and information bars, and containers such as (modal) windows, windows, dialog boxes, palettes, frames and canvas elements. The term “user interface” shall generally be understood to refer to a graphical user interface.

The control widgets may be configured, in an embodiment of the invention, to provide a common user input concept or common user interaction mode for said at least one of an illumination and a detection setting for the plurality of microscopy operation modes regardless of the microscopy operating mode selected. Particularly, the control widgets and optionally the user interface as a whole may allow for an identical, essentially identical or similar user interaction regardless of the operation modes. A user is therefore not required to learn how specific technical operating details define an outcome in a microscopic image which may generally be comparable in the different microscopy operation modes. For example, a user is not required to indicate a sample region scanned in a scanning-type microscopy mode and a used range of a wide-field sensor in a wide-field type microscopy mode but can, for both modes, indicate a desired image size, which is the actual parameter or setting the user is interested in.

The microscope control arrangement may, in an embodiment of the invention, be configured to render, as a part of the graphical user interface, one or more switching widgets configured to change a selection between the plurality of microscopy operation modes. This has the advantage that a user may, using the very same graphical user interface as is used for controlling the illumination or detection parameters, switch between operating modes without distraction, e.g. from a sample observation the user presently performs.

The microscopy operation modes, in an embodiment of the invention, are or include a wide-field operation mode and a confocal operation mode. In such microscope observation modes, the specific settings a user must classically provide or perform to achieve essentially the same or a similar outcome, such as further explained below, are remarkably different. Therefore, in such cases the unified operating concept provided according to the instrumentalities proposed according to an embodiment of the invention is of particular advantage. There is, however, no limitation as to the specific microscope operation modes usable in connection therewith.

The microscope control arrangement may, in an embodiment of the invention, be configured to translate at least one of a user input to a first widget or widget group of the control widgets indicating an imaging time into a parameter or parameter group defining a detector exposure time in the wide-field operation mode and into a parameter or parameter group defining a scan speed in the confocal operation mode. The user is therefore not required to set exposure time and scan speed directly, which may require specific technical knowledge of the different operating concepts, but may perform, in a unified operation concept as proposed herein, perform a target-oriented setting which is then translated to the respective technical parameters.

The same essentially applies when a user input to a second widget or widget group of the control widgets indicating field of view is translated into a parameter or parameter group defining a detector crop in the wide-field operation mode and into a parameter or parameter group defining a scanned region in the confocal operation mode. Again, the user is not required to have knowledge as to the specific technical features responsible to obtain a certain image size or field of view but may instead define the desired result to achieve.

A user input to a third widget or widget group of the control widgets indicating an image resolution may, in an embodiment of the invention, be translated to a parameter or parameter group defining a detector binning in the wide-field operation mode and to a parameter or parameter group defining a scan resolution in the confocal operation mode. Using a unified operating concept comprising this aspect, a user is not required to know that a certain image resolution may essentially be defined by a detector binning in the wide-field operation mode and by a scan resolution in the confocal operation mode but may set the resolution directly.

When a selection between the wide-field and the confocal operation mode is changed, in an embodiment of the invention, activation commands and deactivation commands configured to activate and deactivate different groups of components of the fluorescence microscope used in either of these operation modes may be provided by the microscope control arrangement. That is, in the operating concept proposed herein, an activation and deactivation of different groups of components may be performed using essentially a single switching operation, e.g. a single click, by a user in the user interface. Therefore, a user is not required to activate or deactivate component by component which is particularly of advantage when frequently switching forth and back between operation modes.

The activation commands may, in an embodiment of the invention, be configured to activate at least one of a wide-field detection unit and a wide-field illumination unit when switching from the confocal operation mode to the wide-field operation mode and to activate at least one of a confocal detection unit a confocal illumination unit and an X/Y scanner when switching from the wide-field operation mode to the confocal operation mode. The deactivation commands may be configured to deactivate at least one of a wide-field detection unit and a wide-field illumination unit when switching from the wide-field operation mode to the confocal operation mode and to deactivate at least one of a confocal detection unit, a confocal illumination unit and an X/Y scanner when switching from the confocal operation mode to the wide-field operation mode. As mentioned, providing activation and deactivation commands by essentially a single switching operation improves user-friendliness and reduces switching time.

The control arrangement may, in an embodiment of the invention, be configured to render an overlay of images obtained in each of the plurality of microscope operation modes and to adjust a resolution of the overlay or each of the images. A corresponding embodiment may include that unified or common settings are made for each of the operation modes to allow an overlay to be performed. This further improves a unified operation of a microscope comprising different microscope operation modes and allows for a direct comparison of images obtained in these modes, a pixel-wise comparison.

Furthermore, the control arrangement may, in an embodiment of the invention, be configured to process fluorophore information indicating one or more fluorophores, and to derive control parameters for controlling at least an illumination intensity in each of the plurality of microscopy operation modes. This allows for a fluorophore-oriented operation and an at least initial adjustment of relevant parameters on the basis of the fluorophores without a required detailed knowledge on optimal settings.

In this connection, the microscope control arrangement may, in an embodiment of the invention, be configured to render, as a part of the graphical user interface, one or more fluorophore widgets, wherein the or each of the fluorophore widgets corresponds to the or one of the fluorophores indicated by the fluorophore information, and wherein the or each of the fluorophore widgets comprises a first widget zone and a second widget zone, the first widget zone providing a user feedback relating to the corresponding fluorophore and the second widget zone indicating the illumination intensity of the or one of the light source. In such fluorophore widgets, technical information on the fluorophore selected and the illumination zone are translated to user information provided in an ergonomic and distraction-free manner. A user may evaluate this fluorophore and illumination information without having to leave observation of a sample, for example.

In the or each of the fluorophore widgets, in this connection, the second widget zone may, in an embodiment of the invention, be rendered as a rim surrounding the first widget zone of which a proportion corresponding to the illumination intensity is rendered differently from a remaining proportion. A user may therefore immediately estimate an illumination intensity.

A microscope system comprising a fluorescence microscope and a microscope control arrangement is also provided. As to features and advantages thereof, reference is made to the explanations of different aspects above which also apply to the microscope system.

In a method for controlling a microscope, the method comprises rendering a graphical user interface and, as a part of the graphical user interface, control widgets configured to receive user inputs. The method further comprises translating the user inputs to the control widgets into at least one of an illumination and a detection setting in dependence of a microscopy operation mode selected from of a plurality of microscopy operation modes. Again, as to features and advantages, reference is made to the explanations of different aspects above which apply to method for controlling a microscope as well.

This also holds for a corresponding method according to an embodiment of the invention, in which a microscope control arrangement or a microscope system as explained before in different embodiments is used.

A computer program with program code for performing a method as explained in different aspects before when the computer program is run on a processor is also provided and likewise takes profits of the corresponding advantages.

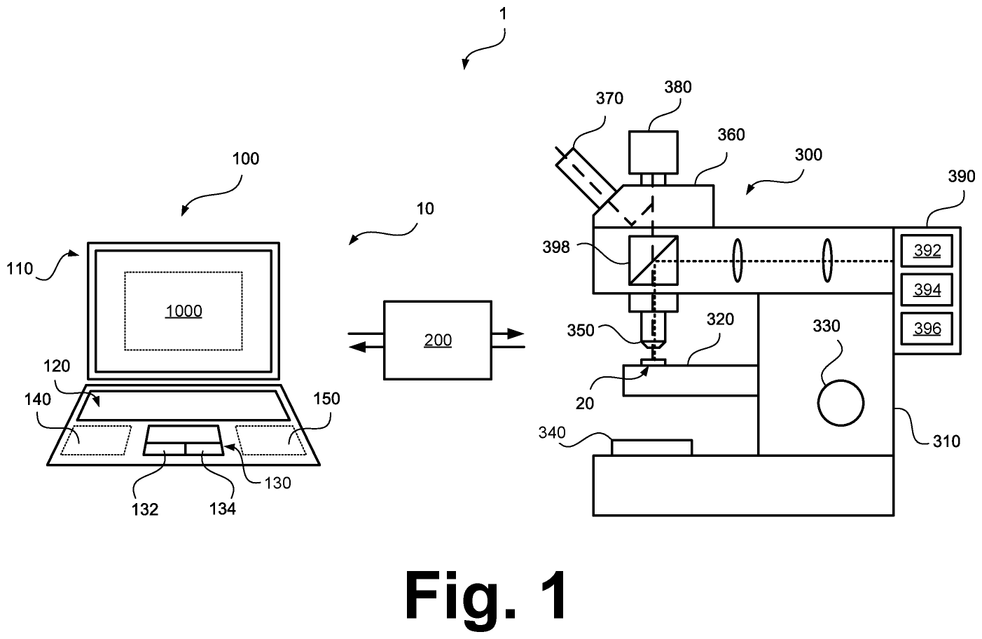

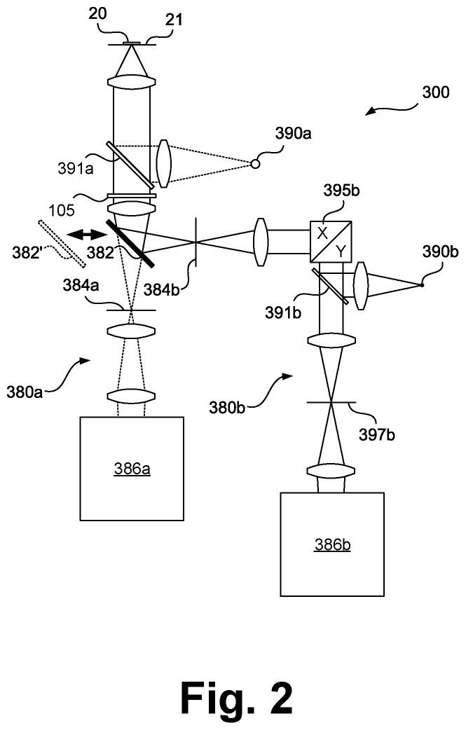

As already mentioned at the outset, microscopes are known which allow a user to select between different microscopy operation modes including, but not limited to, a wide-field and a confocal operation mode. This will be discussed hereinbelow with reference to FIGS. 1 and 2 of which FIG. 1 illustrates a microscope system 1 including such a microscope 300 in a more general way and FIG. 2 illustrates details of switching wide-field and confocal operation and the respective illumination and detection units in such a microscope 300.

As will be explained, not only the technical elements used in such operation modes differ, but also the operation concepts in the operation modes are substantially different from each other. Settings influencing the images obtained in these operation modes include, for example, illumination settings of wide-field light sources (area sensors or “cameras”) versus illumination settings for scanning light sources and components of the respective illumination beam paths, and detection settings for an area detector versus detection settings for components such as line or point detectors and components of the respective detection beam paths. Each of these components may generally, if adjustable, may have an influence on the image results and must therefore be individually and carefully adjusted.

Therefore, conventional operation software for corresponding microscope systems 1 and microscopes 300 includes essentially different user interface elements for each of the operation modes, allowing for a specific and direct adjustment of the elements used in each of the operation modes, respectively. Even if a graphical user interface and a computer control may be used in which certain settings are coupled on the basis of a priori knowledge on their influences on each other, a user still generally has to have detailed knowledge of the technical background of each of the operation modes and what their effect to the result achieved is. Operating a microscope 300 in each of the different operation modes therefore requires a user to “switch” conceptually and mentally between generally different operation and interaction concepts. Particularly for users unexperienced in one of the operation modes, or in more stressful observation situations, such as when observing moving samples, this may be a considerable hurdle and represents a substantial distraction from the actual task of observation and examination of a microscopic sample.

Embodiments of the present invention, in contrast, allow for a unified control of different microscopy operation modes in a unified operation concept which has not yet been realized before due to the different devices, components and their parameters involved. Automatisms, mathematical models and combination of functions, in embodiments of the present invention, may help to share common control elements or widgets between the different operation modes. Appropriate settings for each of the operation modes transparently differentiated in the background without further user interaction.

In other words, according to embodiments of the invention, an advantageous operation concept abstracting an operation of a microscope in different operation modes from the underlying technical details is realized. According to embodiments of the present invention, a target-oriented operation may be realized, i.e. the operation concept may start from or may be centred on the fluorophores used and results to be achieved such as an image resolution, an image size, and an exposure time or rather an acquisition speed. Generally, embodiments of the present invention ensure that a user needs to know generally less about the technology underlying the different operation modes but may focus on actual operation or the quality and parameters of microscopic images. As mentioned, embodiments of the present invention are not limited to wide-field and confocal operation even if described hereinbelow with as focus on these specific microscopy operation modes.

Excitation and detection settings influence the result of spectral un-mixing techniques which may be used in connection with fluorescence microscopy. Spectral un-mixing is a technique which tackles the problems of overlapping emission spectra of fluorophores as a result of cross-excitation or “bleed-through” between different detection channels. These phenomena, when not addressed properly, may lead to false-positive results. Corresponding problems become particularly pronounced when samples are labelled with three or more fluorophores. Spectral un-mixing may include linear un-mixing, non-negative matrix factorization, deconvolution, and principal component analysis. Un-mixing techniques may be based on a priori knowledge of emission spectra or may be used in connection with restricting the number of fluorophores to be the same or lower as the number of detection channels. At its core, and in the understanding as used herein, spectral un-mixing is the task of decomposing mixed multichannel images into spectral signatures and abundances of each signature in each pixel.

As mentioned, FIG. 1 illustrates a microscope system 1 which may be used in embodiments of the present invention. The microscope system 1 may be configured to perform a method described herein. The microscope system 1 comprises a microscope 300 and a computer system 100. The microscope 300 is configured to take images and is connected to the computer system 100 by means of a wired or wireless communication path or interface unit 200. The microscope 300 is configured to be operated in different microscopy operation modes, e.g. a wide-field and a confocal operation mode as further illustrated with reference to FIG. 2. Even if FIG. 1 illustrates an upright microscope 300, embodiments of the present invention may be used with an inverted microscope, details of which are shown in FIG. 2.

The computer system 100 may be configured to execute at least a part of a method described herein. The computer system 100 and the microscope 300, as well as the interface unit 200, which is entirely optional, may be separate entities but can also be integrated together in one common housing. The computer system 100, even if illustrated as a laptop computer, may be part of a central processing system of the microscope 300 and/or the computer system 100 may be part of a subcomponent of the microscope 300, such as a sensor, an actor, a camera or an illumination unit, etc. of the microscope 300. Essentially the same holds true for interface unit 200.

The computer system 100 may be a local computer device (e.g. personal computer, laptop, tablet computer or mobile phone) with one or more processors 140 and one or more storage devices 150 or may be a distributed computer system (e.g. a cloud computing system with one or more processors and one or more storage devices distributed at various locations, for example at a local client and/or one or more remote server farms and/or data centers). The computer system 100 may comprise any circuit or combination of circuits.

In embodiments of the present invention, the computer system 100 may include one or more processors 140 which are illustrated as being integrated into a housing of the computer system 100 in FIG. 1 without limitation. The processor(s) 140 can be of any type and can be provided in any number and at any position and in any component of the microscope system 1. As used herein, the term processor(s) may refer to any type of computational circuit, such as, but not limited to, a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), a multiple core processor, a field programmable gate array device (FPGA), for example, of microscope 300 or any component (e.g. of a camera) of the microscope system 1 or any other type of processor or processing circuit. Other types of circuits that may be included in the computer system 100 may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems.

The one or more storage devices 150 which the computer system 100 may include can comprise one or more memory elements suitable to the particular application, such as a main memory in the form of random access memory (RAM), one or more hard drives, and/or one or more drives that handle removable media such as compact disks (CD), flash memory cards, digital video disk (DVD), and the like.

The computer system 100 may also include a display device 110, one or more loudspeakers, a keyboard 120 and/or one or more user interaction devices, which can be or include a mouse or, as illustrated, a trackpad 130 with buttons 132 and 134, a trackball, a touch screen, a voice-recognition device, or any other device that permits a system user to input information into and receive information from, the computer system 100.

As illustrated in FIG. 1, the computer system 100 may be configured to render, on display device 110, a graphical user interface 1000 which is shown in further and in embodiments below. The computer system 100 may further be configured to provide, via the keyboard and/or the trackpad 130 and/or any further input device, an interaction possibility with the graphical user interface 1000 to operate the microscope system 1.

The microscope 300 is shown to comprise, among others, a microscope housing 310, a stage 320 on which a sample 20 may be placed, a focus adjustment knob 330, a transmitted light illumination unit 340, at least one objective or lens 350, a tube 360 with an eyepiece or eyepiece set 370, a camera or detection unit 380, and an incident illumination unit 390 which is illustrated, without limitation, to comprise different light sources 392 to 396. Light of illumination unit 390 is, as illustrated with a dotted line, coupled into a beam path, which is illustrated with a dashed line, with a beam splitter 398. Further components of an embodiment of a microscope 300 are shown in FIG. 2 and embodiments of the invention are not limited by the specific configuration shown in FIGS. 1 and 2. The microscope may be, via a suitable switching of the light sources 392 to 396 or the illumination unit 390 and detection modalities in the detection unit 380, operable in different microscopy operation modes such as a wide-field and a confocal operation mode.

The computer system 100 and the interface unit 200 may be referred to as a microscope control arrangement 10, but this term, as used herein, is not limited by it comprising a computer and an interface unit 200. The term “microscope control arrangement”, as used herein, is to be understood functionally and to refer to a unit or group of units comprising one or more processors 140 and one or more storage devices 150 provided in a computer system 100 or otherwise and being configured to render a graphical user interface 1000 as described above and further illustrated below in embodiments.

FIG. 2, which will now be described before turning to the description of user interfaces according to embodiments of the invention, illustrates a fluorescence microscope 300 according to an embodiment of the present invention which can e.g. be used as the fluorescence microscope 300 in a microscope system 1 as illustrated in FIG. 1. Fluorescence microscope 300 as illustrated in FIG. 2 comprises two detection units, i.e. a first detection unit 380a and a second detection unit 380b. By means of a switchable or displaceable mirror 382 (as illustrated by a bidirectional arrow), or any other switching means, observation light may selectively be coupled in either the first detection unit 380a or the second detection unit 380b. In the position illustrated in FIG. 2, observation light is coupled via mirror 382 into the second detection unit 380b to the right. If mirror 382 is moved out of the position indicated, as illustrated with 382′, the light path further proceeds to the bottom (in the embodiment illustrated) and thus observation light, as illustrated with dotted rim rays, is coupled into the first detection unit 380a. Optical lenses in an illumination and detection beam path are not specifically indicated.

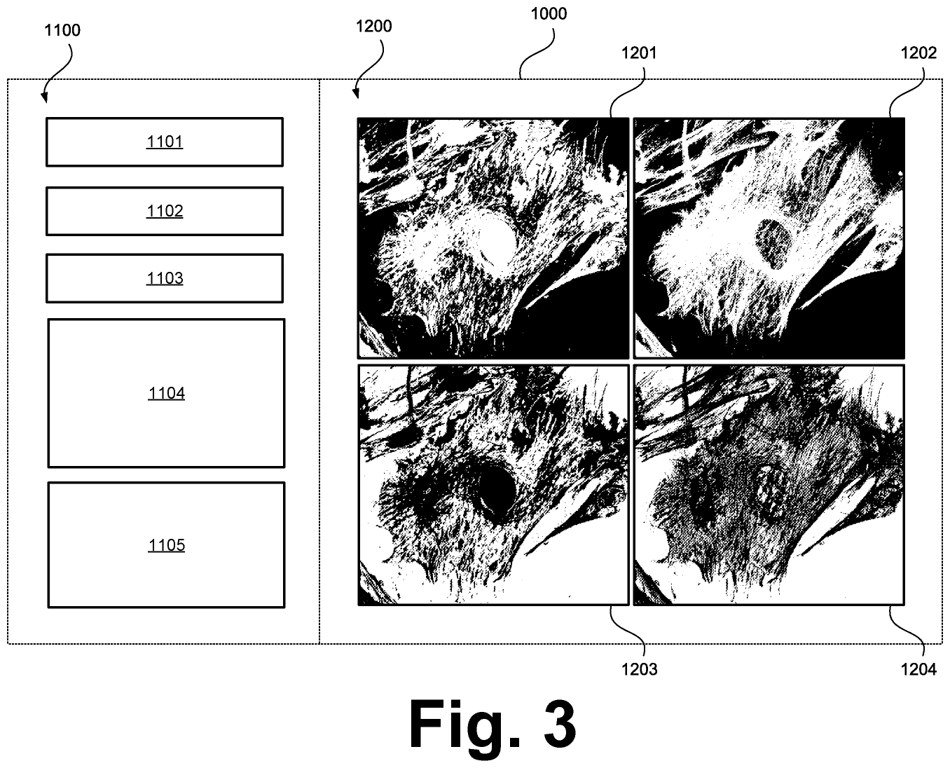

The first detection unit 380a is, in the example shown in FIG. 2, a wide-field detection unit in which an image plane is indicated 384a. By using lenses not specifically indicated, the observation light is collimated and irradiated into a detector arrangement 386a in the first detection unit 380a. Detector arrangement 386a may be configured to split the observation light into different detection channels. As to a detector arrangement 386a usable in the first detection unit 380a, specific reference is made to the EP 3 721 279 B1, to detection unit 10 as illustrated in FIG. 3 therein and the corresponding explanations, and the disclosure is incorporated by reference. An illumination unit for wide-field detection in the first detection unit 380a is illustrated in a simplified manner and indicated 390a. Its light may be coupled into an illumination beam path of the fluorescence microscope 300 in any way known in the art of microscopic illumination, such as using a dichroic mirror 391a.

The second detection unit 380b is, in the example shown in FIG. 2, a confocal detection unit in which an image plane is indicated 384b. A point light source 390b may be provided for confocal detection using confocal detection unit 380b. Point light source 390b may be a (single) pinhole opening into which laser light may be focused, or an end of a light guide or fibre optics from which light emanates in a point-like manner. Point light source 390b is conjugated with an intermediate image plane 384b and an object plane 21 in the sample 20, such that illumination light may, via a dichroic mirror 391b and illumination optics not specifically indicated, be focused to a point of the object plane 21 in a scanned manner using a X/Y scanner 395b which may be arranged in a tele-centric plane or a plane conjugated therewith. This allows for scanning the sample 20 in the sample plane 21, as generally known. A pinhole is indicated 397b. Again, for further details, specific reference is made to EP 3 721 279 B1, to detection unit 20 as illustrated in FIG. 3 therein and the corresponding explanations, and the disclosure is incorporated by reference. The same applied for a detector arrangement 386b which may be configured to split the observation light into different detection channels. Also as to a detector arrangement 386b usable in the second detection unit 380b, specific reference is made to EP 3 721 279 B1, and the disclosure is incorporated by reference.

As evident from the sheer number of components present in a microscope operable in different microscopy operation modes, such as the microscope 300 as illustrated in FIG. 2, a very large number of settings may be performed in each of these operation modes separately, including, but not limited, a selection or intensity of a light source 392 to 396 and possibly corresponding filters in either of the operation modes. Furthermore, such settings include detector settings such as, in a wide-field operation mode, an exposure time, a sensor gain, an area sensor crop, an area sensor binning or the selection of a specific area sensor, and, in a confocal operation mode, a scan speed, a scan resolution, a pinhole size, a detector gain and the selection of a specific detector used. While the setting or adjustment of operation parameters of some of these components can be simplified e.g. by selecting suitable default values, using optimization algorithms, coupling suitable adjustments, etc., the adjustment of at least some of the components used in either one of the operation modes is conceptually strictly separated in conventional arrangements.

Therefore, a user still generally has to have detailed knowledge of the technical background of each of the operation modes and what their effect to the result achieved is. As mentioned, a user is required a user to “switch” conceptually and mentally between generally different operation and interaction concepts in conventional arrangements. This problem is overcome according to embodiments of the present invention, in which, as will now be further explained, a unified control of a microscope (system) in different microscopy operation modes in a unified operation concept is realized.

In other words, according to embodiments of the invention, an advantageous operation concept abstracting an operation of a microscope in different operation modes from the underlying technical details is realized. In such a concept, a user interface 1000 as generally illustrated in FIG. 3 can be used, wherein components of the user interface 1000 may be arranged in the manner illustrated but also in any other form conceivable.

As illustrated in FIG. 3 without limitation, user interface 1000 may be divided into an input panel 1100 including a plurality of input widgets or widget groups 1101 to 1105, and a display panel 1200 in which, in the example illustrated in FIG. 3, four different images 1201 to 1204 obtained by capturing fluorescence responses in four different channels are displayed. Said images may be obtained in either one of the microscopy operation modes, i.e. they may be outputs of different area sensors in a detection unit 380 used in a wide-field operation mode or they may be representations of scanning responses captured in one or more detectors or sensors used in a confocal operation mode. Images 1201 to 1204 may also be overlays of two or more fluorescence responses used in the same microscopy operation mode or in different microscopy operation modes wherein they also may be resolution-adjusted to each other or to a common value in embodiments of the present invention. At least one of images 1201 to 1204 may also a two-dimensional representation of three-dimensional image data such as a slice through, or a projection to a plane of, such three-dimensional image data.

Embodiments of the present invention are not in any way limited by the number or the images 1201 to 1204 displayed and their origin, manner of processing, or source. For example, images 1201 to 1204 may also be displayed in pseudo-colour(s) or, when captured as greyscale images, as (pseudo-) coloured representations. For example, images 1201 to 1204 may be displayed in colours corresponding to a peak of a fluorescence emission spectrum in a fluorescence channel in which the images 1201 to 1204 are captured, or a display colour may be freely selected by a user of a microscope system 1 or the microscope control arrangement 10, for example in order to differentiate them in an overlay image. Thus an overlay of the single channels with different colours is possible. If the user uses fluorophores that are very close to each other in the sample (e.g. Alexa 568 and Alexa 594 are both orange fluorophores), the structures in the overlay from the two channels are natively detected in the same colour. Here one could like to have a contrast as large as possible, in order to be able to distinguish both fluorophores better. To solve this problem, a user may assign a different display colour to one or both fluorophores.

Images 1201 to 1204 may be displayed as static images 1201 to 1204 or as motion images 1201 to 1204 or a mixture of static and motion images 1201 to 1204, and the user interface may be configured to switch between a static and motion view of images 1201 to 1204, for example to take “snapshots” of a moving sample, in predefined time intervals or in response to a request of a microscope user, e.g. via a widget of the user interface 1000. A mixed view of static images 1201 to 1204 and motion images 1201 to 1204 at the same time may also generally be provided according to embodiments of the present invention, for example to be able to visually track a motion of a sample 20 or a component of a sample 20 and in parallel to inspect the sample 20 or the component of the sample 20 in detail.

Aspects of embodiments of the present invention may include acquiring and/or displaying images 1201 to 1204 such as shown in FIG. 3 via different microscopy operation modes and potentially in different detection modes, sizes, resolutions, detection channels, etc., but, for obtaining such images 1201 to 1204, to use a common control concept via the user interface 1000. Aspects include setting parameters for different microscopy operation modes using the same user interface widgets and transparently translating corresponding user inputs to specific settings for either of the operation modes.

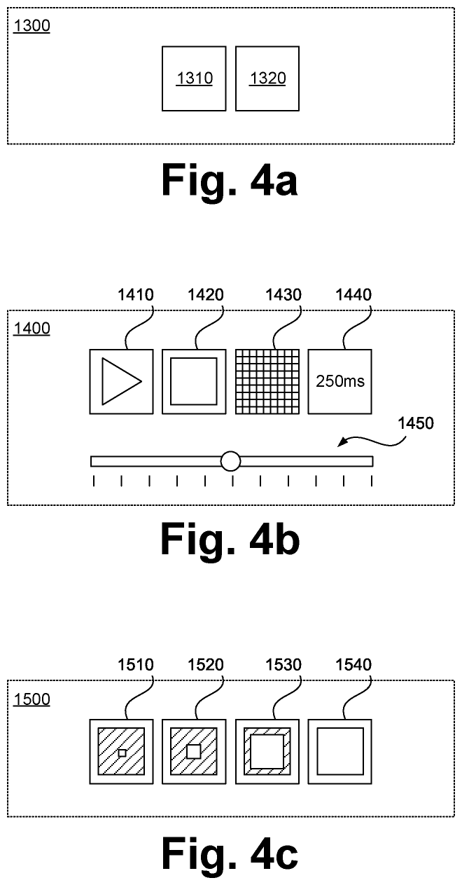

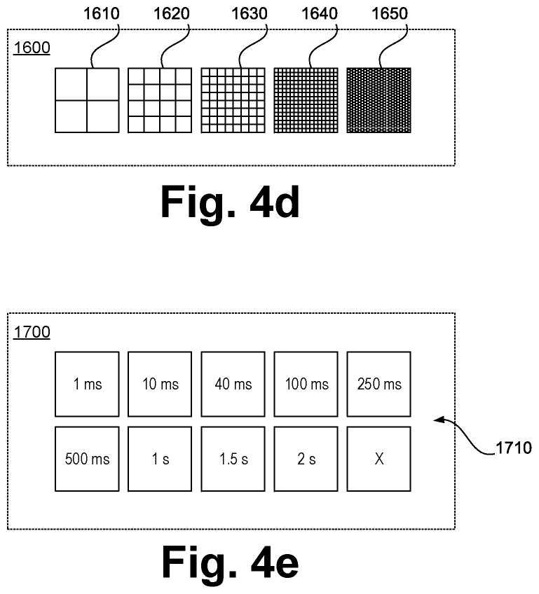

This is realized, in embodiments of the invention, using control widgets 1410 to 1710 in widget groups 1400 to 1700 illustrated in FIGS. 4b to 4e. Widget groups 1400 to 1700 may replace or be part of widget groups 1101 to 1105 as illustrated in FIG. 3. As illustrated in FIG. 4a, furthermore, a widget group 1300 with widgets 1310 and 1320 may be provided.

A microscope control arrangement 10 according to an embodiment of the present invention may configured to render, as a part of a graphical user interface 1000 such as illustrated before, said widgets 1310 and 1320 in the form of switchover widgets, e.g. buttons configured to change a selection between the plurality of microscopy operation modes. By selectively operating widgets 1310 and 1320, a user may therefore switch between these microscopy operation modes such as a wide-field operation mode and a confocal operation mode. Widgets 1310 and 1320 may also be grouped or substituted by a single widget, in the case of exactly two microscopy operation modes which may be configured to toggle between the operation modes. Each of said widgets 1310 and 1320, or a single widget, may also provide a feedback as to which of the microscopy operation modes is selected. For example, the selected one of the widgets 1310 may be displayed in a highlighted mode and the other may be displayed in a faded or greyed-out mode, or a text in the user interface may be provided, said text changing in response to a selection.

Switching e.g. between wide-field and confocal operation is done with a single click in the user interface using switchover widgets 1310 and 1320 or a single widget. As a response, the microscope control arrangement 10 adjusts individual settings on the microscope 300 or the microscope system 1 automatically, e.g. to set up the beam path for the respective method and to perform pre-adjustments for illumination and detection settings, e.g. using sensible default values. After switching, the user interface elements may remain unchanged in an embodiment of the present invention, or they may change but still be provided to receive user inputs in an essentially unchanged manner. The advantage for users is, in a corresponding embodiment, that they can always use the same control widgets, regardless of the microscopy operation mode selected. This enables more efficient work without having to know and adjust the specific setting of the respective mode.

Besides the switchover widgets 1310 and 1320, in embodiments of the present invention, control widgets 1410 to 1710 in widget groups 1400 to 1700 may be provided as a part of the graphical user interface 1000. In embodiments of the present invention, only a part of said control widgets 1410 to 1710 or of said widget groups 1400 to 1700 may be provided, or the control widgets 1410 to 1710, or any number of widgets, may be grouped in different ways. The control widgets 1410 to 1710, or any different number of control widgets or a subset thereof, are generally configured to receive user inputs. The microscope control arrangement 10 is configured to translate the user inputs to the control widgets 1410 to 1710 or any other number of widgets or a subset thereof, into at least one of an illumination and a detection setting in dependence of a microscopy operation mode selected from of a plurality of microscopy operation modes. This will now be further explained for embodiments of the present invention with specific reference to FIGS. 4b to 4e.

In embodiments of the present invention, the control widgets 1410 to 1710 may be configured to provide a common user interaction modality for said at least one of an illumination and a detection setting for the plurality of microscopy operation modes regardless of the microscopy operating mode selected. Such control widgets 1410 to 1710 may be rendered graphically identically, similarly, or differently in the different operation modes, as generally mentioned before, but in a manner in which they allow a unified control of different microscopy operation modes.

The widget group 1400 including widgets 1410 to 1440 (or a subset thereof) as illustrated in FIG. 4a may generally a widget group of a higher hierarchy in a unified operation concept provided according to embodiments of the present invention, wherein widgets 1420, 1430 and 1440 may trigger rendering or activation of widget groups 1500, 1600 and 1700 as illustrated in FIGS. 4c to 4e, e.g. in the same or a different user interface region of the user interface 1000. Widget 1410 may e.g. be configured to trigger an auto-illumination procedure. This auto-illumination procedure may include a value adjusted with a slider 1450 in the calculation and, initially, images with stored or default settings of a field of view, a resolution, and a frame duration, which may be modified using control widgets 1420 to 1440 is displayed, in a display region 1200 of a user interface 1000. Different parameters may be used in the background for the two acquisition methods.

More specifically, a widget 1410 may be configured to enable a user to manually trigger an auto-illumination control process, this process being provided for automatically determining optimized illumination settings for a sample 20. In this connection, a user may, via a further widget 1450, e.g. in the form of a slider, indicate a value indicating a sensitivity of a sample 20 for illumination light, e.g. of a specific wavelength, can be adjusted by a user in a non-limiting embodiment of the invention. Corresponding calculations and optimizations may be performed in the background for different microscopy operation modes and values obtained on this basis may be switched upon operating widgets 1310 and 1320 or a single widget as explained before in connection with FIG. 4a.

In the microscope 300 or microscope system 1 operated using user interface 1000, default or predetermined values for further settings may be used, which will now be explained for the specific example of wide-field and confocal operation. These may include a detector exposure time in the wide-field operation mode and a scan speed in the confocal operation mode, a detector crop in the wide-field operation mode and a scanned region in the confocal operation mode, and a detector binning in the wide-field operation mode and a parameter or parameter group defining a scan resolution. These three pairs of parameters may, if adjusted accordingly, generally translate to comparable image results despite being obtained using substantially different settings for the actual components of a microscope 300 or microscope system 1. In embodiments of the present invention, such pairs of settings may be adjusted using the very same widgets, wherein a setting made for a result to be achieved, e.g. image resolution, size and imaging speed, are automatically translated, according to an embodiment of the invention, to the specific settings in both modes.

As illustrated in FIG. 4c, a user input to a widget or widget group 1500 of the control widgets 1510 to 1540 indicating a field of view may be received and this user input may be translated into a parameter or parameter group defining a detector crop in the wide-field operation mode and into a parameter or parameter group defining a scanned region in the confocal operation mode, both parameters defining the image size.

Generally, a user of the microscope control arrangement 10 is expected to know the sample 20 examined and the specific application and may therefore specify the size of the exposure field here accordingly. The user may be offered, in embodiments, image sizes for wide-field and confocal operation in the form of fixed sizes, for example “full frame”, “⅔ frame”, “⅓ frame” and “⅙ frame” and such sized may be visually displayed. In embodiments, intermediate sizes are not offered to ensure compatibility of the two acquisition methods. A user is, as frequently mentioned, not required to have extended knowledge of the parameters actually used for obtaining images of corresponding sizes.

As illustrated in FIG. 4d, a user input to a widget or widget group 1600 of the control widgets 1610 to 1650 indicating an image resolution may be translated to a parameter or parameter group defining a detector binning in the wide-field operation mode and to a parameter or parameter group defining a scan resolution in the confocal operation mode.

Here the user has the possibility to set the resolution of the image. If the user is interested in an overlay of wide-field and confocal images, for example, the user can adjust the camera or scanner resolution to each other. Thus, a pixel-precise overlay is possible. Binning may include a binning of 2×2 or 4×4 pixels or any other number of pixels of an area detector, and a resolution in a scanning mode may be defined by using a width of a pinhole.

Finally, as illustrated in FIG. 4e, a user input to a widget or widget group 1700 of the control widgets indicating an imaging time or “frame rate” may be translated into a parameter or parameter group defining a detector exposure time in the wide-field operation mode and into a parameter or parameter group defining a scan speed in the confocal operation mode.

A corresponding setting can therefore be used to specify the time for the exposure and the auto-illumination. In this way, it is possible to influence the duration of the light exposure in order to protect the specimen. In a wide-field mode, the frame duration may be equivalent to an exposure time of the cameras. The user can select from predefined values or specify an own setting. In a confocal mode, the minimum value of the duration is calculated from the maximum scan speed, taking into account the currently set field of view and resolution. The other times are multiples of the minimum value under the condition that the best quality is achieved as efficiently as possible.

Aspects of embodiments of the present invention may include acquiring and/or displaying images 1201 to 1204 such as shown in FIG. 3, potentially via different microscopy operation modes, and potentially in different detection modes, sizes, resolutions, detection channels etc., but, for obtaining such images 1201 to 1204, to use a fluorophore-based control concept via the user interface 1000. Aspects include setting parameters on the basis of predefined fluorophore information, and potentially for different microscopy operation modes, using the same user interface widgets and transparently translating corresponding user inputs to specific settings for detection, potentially for either of the operation modes.

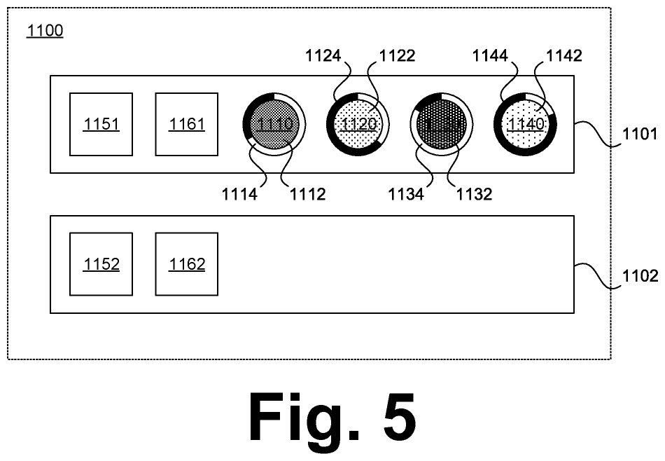

This is realized, in embodiments of the present invention, and as illustrated in FIG. 5, using fluorescence control widgets 1110, 1120, 1130, 1140 in a widget region which may correspond, without limitation, to input panel 1100 as already illustrated in FIG. 3 and is therefore referred to as an input panel here as well. Sub-panels 1101 and 1102 of the input panel 1100 may be provided in embodiments of the present invention, or only one sub-panel may be provided. Sub-panels 1101 and 1102 may or may not resemble the widget groups 1101 and 1102 as illustrated in FIG. 3 or may be provided as additional widgets or widget groups. Fluorescence control widgets 1110, 1120, 1130, 1140 are user interface components with which, as further explained below, a fluorophore-based operation according to embodiments of the present invention referred to above may be realized.

To this purpose, each of the fluorophore control widgets 1110, 1120, 1130, 1140 is provided to correspond to the or one of the fluorophores indicated by the fluorophore information. The number of control widgets 1110, 1120, 1130, 1140 is dynamic and depends on the number of fluorophores indicated and specified by a user, for example in sample information in which such fluorophore information are provided in addition to other sample parameters as indicated above. Alternatively, fluorophore information may be provided by a user separately from further sample information or without sample information. Fluorophore information may, whether or not being provided in addition to or together with sample information, and without limitation, include at least one of a name of the fluorophore, an excitation wavelength or wavelength range usable for exciting the fluorophore, and an emission wavelength or wavelength range characterizing a fluorescence response of the fluorophore. Wavelength ranges may be provided in the form of a centre wavelength and a bandwidth of a wavelength band. Fluorophore information may also comprise information on a chemical or physical stability of a fluorophore. For example, and without limitation, one, two, three, four or five fluorophores may be specified in fluorophore information, the number corresponding to, or being smaller than, a number of detection channels (i.e. camera chips, area detectors, scanning detectors, etc.) of the microscope 300.

The control widgets 1110, 1120, 1130, 1140 are provided to provide a user with information on, and an interaction possibility with, the excitation and the detection of the fluorophores they correspond to. The control widgets 1110, 1120, 1130, 1140 may optionally substitute conventional information widgets information means of a graphical or non-graphical user interface conventionally used to provide information on illumination settings, a fluorescence response, and parameters set in a corresponding microscope, and they may optionally substitute adjustment means for such an illumination and detection.

The control widgets 1110, 1120, 1130, 1140 are control elements that allow a user to make all settings relating to different fluorophore with a small number of interaction steps, such as a few mouse clicks. Without expert knowledge, the user can set up an experiment for a specific problem using the control widgets 1110, 1120, 1130, 1140. In doing so, the user may proceed much faster to obtain meaningful results as compared to conventional systems. This time saving applies to both wide-field and confocal microscopy, if a corresponding microscope 300 is configured to be operated in these modes. On the confocal side, the savings are even greater, because mathematical models stored for this mode of operation take intrinsically more parameters into account, which users no longer have to set theirself and for each component concerned.

The control widgets 1110, 1120, 1130, 1140 may thus be used for different microscopy operation modes or detection types, and a user interaction with the control widgets 1110, 1120, 1130, 1140 may be translated to either of the operation modes or detection types, realizing a common control concept via the user interface 1000. Aspects of embodiments of the present invention therefore include setting parameters for different microscopy operation modes, such as a wide-field and a confocal mode, using the same user interface widgets and transparently translating corresponding user inputs to specific settings for either of the operation modes, as further explained below.

As illustrated in FIG. 5, each of the fluorophore control widgets 1110, 1120, 1130, 1140 comprises a first widget zone 1112, 1122, 1132, 1142 and a second widget zone 1114, 1124, 1134, 1144, the first widget zone 1112, 1122, 1132, 1142 providing a user feedback indicating the corresponding fluorophore and the second widget zone 1114, 1124, 1134, 1144 indicating an illumination intensity associated with the fluorophore. The fluorophore control widgets 1110, 1120, 1130, 1140, which are illustrated as round buttons in FIG. 5, may each provide information to a user relating to a nature of the fluorophore specified and the illumination intensity presently used. Therefore, a bimodal nature of the fluorophore control widgets 1110, 1120, 1130, 1140 is present and each of the fluorophore control widgets 1110, 1120, 1130, 1140 provides the users at one position and in an intuitive manner with essentially all the information they need. The fluorophore control widgets 1110, 1120, 1130, 1140 may be configured to provide the first widget zone 1112, 1122, 1132, 1142 in a colour which corresponds to, or is provided on the basis of, the (main) excitation or emission wavelength of the fluorophore the fluorophore control widgets 1110, 1120, 1130, 1140 relates to and on whose basis it is provided using the fluorophore information. A colour may also be freely selected by a user.

The fluorophore control widgets 1110, 1120, 1130, 1140 may be configured to provide the second widget zone 1112, 1122, 1132, 1142 in a manner which informs the user of an illumination intensity, e.g. of a light source 392, 394, 396 such as a light emitting diode or a laser, which is used for illuminating the sample and exciting the corresponding fluorophore. The user may therefore, without distraction and without e.g. selecting a different window or part of the user interface, be informed at any time on the illumination intensity and in this way be warned of a too high and/or extended illumination to avoid damaging the fluorophore. Parameters of displaying the illumination intensity may also be adjusted on the basis of the fluorophore information, e.g. taking into account the stability of the fluorophore.

In an embodiment illustrated in FIG. 5, the second widget zone 1114, 1124, 1134, 1144 is, in each case, rendered as a rim surrounding the first widget zone 1112, 1122, 1132, 1142 of which a proportion corresponding to the illumination intensity is rendered differently from a remaining proportion. The proportion corresponding to the illumination intensity may be linearly correspond to the illumination intensity or be provided on the basis of a function, such as an exponential or irregular function, e.g. when a fluorescence response or emission is not linearly dependent on the illumination intensity.

When the second widget zone 1114, 1124, 1134, 1144 is rendered as a rim surrounding the first widget zone 1112, 1122, 1132, 1142, a brighter part of the rim may correspond to the illumination intensity in the form of a percentage of a maximum illumination intensity and a darker part may be corresponding to a remainder. The brighter part is displayed in white in FIG. 5 and the darker part is illustrated in black. The maximum illumination intensity may be a true maximum illumination intensity of a light source, or the light source presently used, or may be a maximum allowed illumination intensity defined elsewhere, such as in fluorescence or sample information. The maximum allowed illumination intensity may be selected on the basis of a fluorophore stability. In an embodiment, when certain illumination settings are exceeded, the second widget zone 1114, 1124, 1134, 1144, or a part thereof, may also be rendered in a “warning” colour, e.g. in red or orange, to warn a user of a possible sample damage.

In the example illustrated in FIG. 5, the second widget zone 1114 displays an illumination intensity of about 60%, the second widget zone 1124 displays an illumination intensity of about 40%, the second widget zone 1134 displays an illumination intensity of about 80%, and the second widget zone 1144 displays an illumination intensity of about 20%. This display is particularly intuitive for a user as it resembles the minutes of an hour as indicated by the hands of a conventional watch or clock where the full circle corresponds to the full hour and sections thereof correspond to proportions of the hour.

In fluorescence microscopy, especially with living specimens, the avoidance or at least reduction of the bleaching effect plays a very important role. With conventional systems, the user has to adjust the light manually. Embodiments of the present invention may relieve the user of this task. Controls for adjusting and balancing or laser intensities may longer exist. An auto-illumination procedure may be used to calculate the optimal light intensities. However, since many different combinations of fluorophores in a sample may be present, very different dynamics in intensity between different wavelengths may be encountered. For this reason, it is of great interest to the user to get a feedback of the light exposure of his sample. The second widget zone 1114, 1124, 1134, 1144, in the way discussed, may be used for this purpose. The second widget zone 1114, 1124, 1134, 1144 shows, per fluorophore, the illumination intensity, e.g. of the main excitation laser or light emitting diode, for example in relation to the used attenuator. Thus, the user has direct feedback for the used intensities and can at each step of an experiment evaluate the light exposure of the sample with only a short look at the fluorophore control widgets 1110, 1120, 1130, 1140 and take corrective action if necessary.

A colour of the second widget zone 1114, 1124, 1134, 1144, or more precisely the part thereof indicating the illumination intensity, may be rendered in a colour relating to, or resembling the, excitation wavelength used for the corresponding fluorophore, according to an embodiment of the present invention.

Further control widgets 1151, 1152, 1161, 1162 may be provided, which may be adapted to start an experiment or an acquisition of data and a fast acquisition mode or any other parameters relating to an experiment.

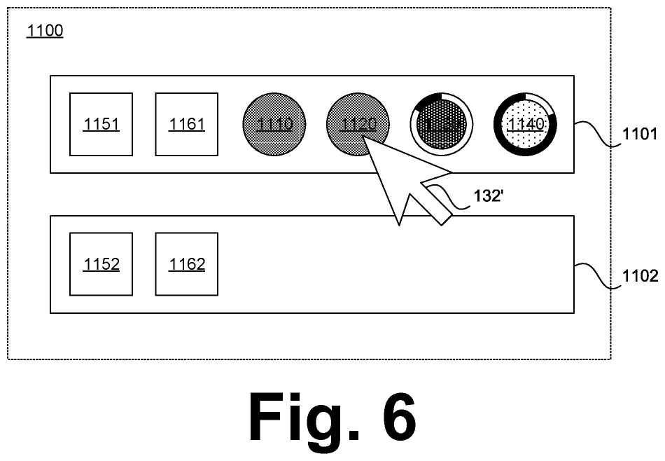

FIG. 6 illustrates a user input to fluorescence control widgets according to an embodiment of the present invention. Components and their functions illustrated in FIG. 6 have been, in some part, already been explained in connection with FIG. 5, and thereof only additional components are further explained below.

As illustrated in FIG. 6, using user interaction means such as a mouse or trackpad 130 as already illustrated in FIG. 1, the user may interact with the control widgets fluorophore control widgets 1110, 1120, 1130, 1140. In FIG. 6, a mouse pointer is indicated 132′ and the user may, e.g. using a left mouse button or any interaction mode suitable, click the fluorophore control widgets 1110, 1120, 1130, 1140. In response, as illustrated with greyed-out fluorophore control widgets 1110, 1120, the corresponding illumination and detection may be switched off with a single user operation. For example, a detection channel may also be switched of or ignored and a fluorescence response can be ignored or not considered in a fluorescence un-mixing method used in resolving the fluorescence responses from different fluorophores, according to an embodiment of the present invention.

In more general terms, the microscope control arrangement 10 the user interface 1000 is rendered with is configured to toggle, in response to the user interaction in one of the interaction modes, at least one of an illumination for exciting the corresponding fluorophore, use of fluorophore information relating to the corresponding fluorophore in an un-mixing method determining contributions of the fluorophore in a common fluorescence response, and displaying an image obtained on the basis of a fluorescence response of the corresponding fluorophore. As mentioned, according to the embodiment illustrated here, a plurality of settings is toggled with a single operation.

When a user is searching for an interesting location in three dimensions in a sample, the system must be set to live mode and the sample must be illuminated. Here it is important to protect the sample from illumination to the maximum extent possible for the duration of the search. It is not always necessary to illuminate all fluorophores for this procedure. This makes it possible to switch off all light sources that are not needed. By left-clicking the fluorophore control widgets 1110, 1120, 1130, 1140 (or any other way of interaction defined), it is possible to deactivate or activate fluorophores which is equivalent to indirectly switching on or off the corresponding light sources, but in a more user-friendly manner. Switching forth and back between activation and deactivation is substantially easier. A switched off fluorophore may be represented by a fluorophore control widget 1110, 1120 in grey or in a faded representation. If the corresponding light source it is activated, the first widget zone 1112, 1122, 1132, 1142 may be rendered in a colour corresponding to, or selected on the basis of, the emission colour or any other colour defined by a user for a display colour in the display panel 1200, for example a (pseudo-) colour as mentioned above.

By interacting with the fluorophore control widgets 1110, 1120, 1130, 1140 in a specific interaction mode, for example by right-clicking, the colour used in the display panel 1200 for an image of the corresponding fluorophore may be changed, as explained for fluorophores in colours which are very close to each other in the sample. If a user selects a new colour, the first widget zone 1112, 1122, 1132, 1142 may be rendered accordingly.

In an embodiment of the present invention, selecting and deselecting fluorophores by acting upon the fluorophore control widgets 1110, 1120, 1130, 1140 may initiate a new auto-illumination procedure because the illumination scenario has changed, e.g. a cross-excitation of other fluorophores is reduced.

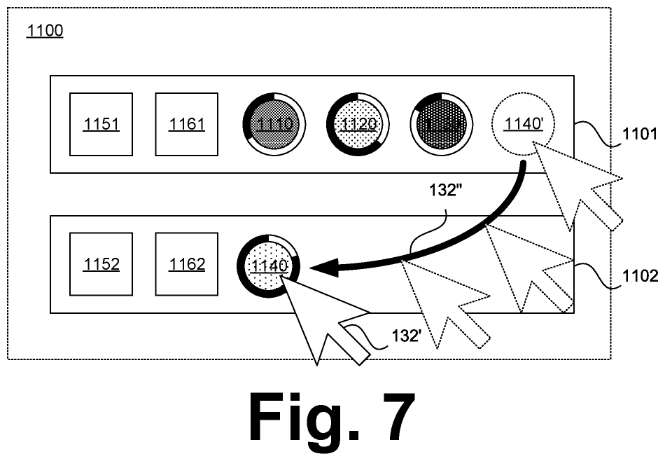

FIG. 7 illustrates regrouping fluorescence control widgets. Again, several components and their functions illustrated in FIG. 7 have been, in a large part, already been explained in connection with FIGS. 5 and 6 above, and thereof only additional subject matter and components are further explained below.

In practice, there are combinations of fluorophores whose spectra overlap unfavourably and un-mixing thereof is not possible. Instead of excluding such combinations for a microscope system 1, a sequential acquisition can be used as a fall-back. By a drag-and-drop operation, the user can, in an embodiment of the invention illustrated in FIG. 7, separate interfering fluorophores and split them to new sequences. Complicated combinations can thus, in a corresponding embodiment, be recorded in just a few seconds.

To this purpose, a microscope control arrangement 10 provided according to an embodiment of the invention may be configured to reposition the fluorophore control widgets 1110, 1120, 1130, 1140 in the graphical user interface 1000 upon determining an interaction in one of the interaction modes. In the example illustrated, the excitation and detection of the fluorophores is determined to be performed sequentially or in parallel on the basis of a state of a grouping of the corresponding fluorophore control widgets 1110, 1120, 1130, 1140 in the graphical user interface 1100. As shown in FIG. 7, fluorophores corresponding to fluorophore control widgets 1110, 1120, 1130 grouped in user interface region 1101 are excited and detected in parallel. The fluorophore control widget 1140, which is moved by a user from the user interface region 1101 to the user interface region 1102 by a drag-and-drop operation, is removed from the parallel excitation and detection, and therefore the fluorophore corresponding to fluorophore control widget 1140 is excited and detected subsequently. The drag-and-drop operation is illustrated with a mouse pointer 132′ along an arrow 132″ starting at a starting position 1140′ and ending at the new position in the region 1102.

Obviously, further sequential excitation and detection can be configured by providing further user interface regions such as the interface regions 1101, 1102 and in each of the interface regions 1101, 1102 any number of fluorophore control widgets 1110, 1120, 1130, 1140 may be grouped in order to demand a parallel excitation and detection.

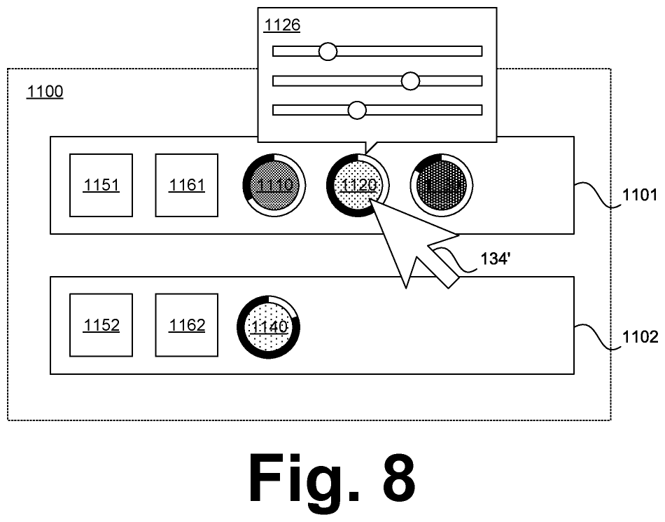

FIG. 8 illustrates a user input to fluorescence control widgets in a further embodiment of the present invention. As before, several components and their functions illustrated in FIG. 8 have been, in a large part, already been explained above, and thereof only additional subject matter and components are further explained below.

Auto-illumination provides the user with an image with an improved or optimized signal-to-noise ratio in relation to the current lighting environment. However, the image impression can be subjectively evaluated very differently by a user. To enable a user a leeway in this connection, a fine adjustment of the auto-illumination may be provided in an embodiment of the present invention as a response to a user interaction with the fluorophore control widgets 1110, 1120, 1130, 1140 in a user interaction mode such as a mouse-over operation.

In other words, by providing a fine-tuning panel 1126 comprising suitable means according to such an embodiment, the image impression can be adjusted to the user's personal preferences. If the user moves, in other words, the mouse over one of the fluorophore control widgets 1110, 1120, 1130, 1140, a slider or slider set may be displayed after a certain time, e.g. for a few seconds, which can be used for fine-tuning. An “optimize” button may be provided to restart auto-illumination and the new parameters may be incorporated into the image. Slider values may, in an embodiment, also be changed via a mouse wheel.

In more general terms, a microscope control arrangement 10 used herein may be configured to render a fine-tuning panel 1126 in response to the interaction in one of the interaction modes. And the microscope control arrangement 10 may be configured to modify the control parameters on the basis of a user input received using the fine-tuning panel 1126, control parameters relating to an auto-illumination setting.

As used herein the term “and/or” includes any and all combinations of one or more of the associated listed items and may be abbreviated as “/”.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments of the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine readable carrier.

Other embodiments comprise the computer program for performing one of the methods described herein, stored on a machine readable carrier.

In other words, an embodiment of the present invention is, therefore, a computer program having a program code for performing one of the methods described herein, when the computer program runs on a computer.

A further embodiment of the present invention is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium.

A further embodiment of the invention is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment of the invention comprises an apparatus or a system configured to transfer (for example, electronically or optically) a computer program for performing one of the methods described herein to a receiver. The receiver may, for example, be a computer, a mobile device, a memory device or the like. The apparatus or system may e.g. comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Microscope system
10 Microscope control arrangement
20 Sample
21 Object plane
100 Computer system
110 Display
120 Keyboard
130 Trackpad
132 First button
132′ Mouse pointer
132″ Movement arrow
134 Second button
140 Processor(s)
150 Storage device(s)
200 Interface unit
300 Microscope
310 Microscope housing
320 Microscope stage
330 Focus adjustment knob
340 Transmitted light illumination unit
350 Microscope objective
360 Microscope tube
370 Eyepiece set
380 Detection unit
380a, 380b Wide-field and confocal detection units
382 Displaceable mirror
382′ Displaced mirror position
384a, 384b Wide-field and confocal image planes
386a, 386b Wide-field and confocal detector arrangements
390 Incident illumination unit
390a, 390b Wide-field and confocal illumination units
391a, 391b Dichroic mirrors
392-394 Light sources
395b X/Y scanner
397b Pinhole
1000 Graphical user interface
1100 Input panel
1101-1105 Input widgets or widget groups, sub-panels
1126 Fine-tuning panel
1140′ Starting position
1200 Display panel
1201-1204 Images
1300-1700 Widget groups
1310, 1320 Switchover widgets
1410-1440 Control widgets
1510-1540 Control widgets
1610-1640 Control widgets
1710 Control widgets
1110-1140 Fluorescence control widgets
1112-1142 First widget zone
1114-1144 Second widget zone

1. A microscope control arrangement comprising:
one or more processors, and
one or more storage devices, wherein the one or more processors are configured to render a graphical user interface on a display device, the graphical user interface including control widgets configured to receive user inputs, wherein the one or more processors are further configured to translate the user inputs to the control widgets into at least one of an illumination setting or a detection setting in dependence of a microscopy operation mode selected from of a plurality of microscopy operation modes.

2. The microscope control arrangement according to claim 1, wherein the control widgets are configured to provide a common user interaction mode for the at least one of the illumination setting and the detection setting regardless of the microscopy operating mode selected from the plurality of microscopy operation modes.

3. The microscope control arrangement according to claim 1, wherein the graphical user interface further includes one or more switching widgets configured to change a selection between the plurality of microscopy operation modes.

4. The microscope control arrangement according to claim 1, wherein the plurality of microscopy operation modes include a wide-field operation mode and a confocal operation mode.

5. The microscope control arrangement according to claim 4, wherein the one or more processors are configured to translate at least one of:
a first user input to a first widget or a first widget group of the control widgets indicating an imaging time into a parameter or a parameter group defining a detector exposure time in the wide-field operation mode or into a parameter or a parameter group defining a scan speed in the confocal operation mode,
a second user input to a second widget or a second widget group of the control widgets indicating field of view into a parameter or a parameter group defining a detector crop in the wide-field operation mode or into a parameter or a parameter group defining a scanned region in the confocal operation mode, and/or
a third user input to a third widget or a third widget group of the control widgets indicating an image resolution to a parameter or a parameter group defining a detector binning in the wide-field operation mode or to a parameter or a parameter group defining a scan resolution in the confocal operation mode.

6. The microscope control arrangement according to claim 4, wherein the one or more processors are further configured to, when a selection between the wide-field operation mode and the confocal operation mode is changed, provide activation commands and deactivation commands configured to activate and deactivate different groups of components of a fluorescence microscope used in the wide-field operation mode or the confocal operation mode.

7. The microscope control arrangement according to claim 6, wherein the activation commands are configured to activate at least one of a wide-field detection unit and/or a wide-field illumination unit when switching from the confocal operation mode to the wide-field operation mode, and to activate at least one of a confocal detection unit, a confocal illumination unit and/or an X/Y scanner when switching from the wide-field operation mode to the confocal operation mode.

8. The microscope control arrangement according to claim 6, wherein the deactivation commands are configured to deactivate at least one of a wide-field detection unit and/or a wide-field illumination unit when switching from the wide-field operation mode to the confocal operation mode, and to deactivate at least one of a confocal detection unit, a confocal illumination unit and/or an X/Y scanner when switching from the confocal operation mode to the wide-field operation mode.

9. The microscope control arrangement according to claim 1, wherein the graphical user interface further includes an overlay of images obtained in each of the plurality of microscope operation modes, and the one or more processors are configured to adjust a resolution of each of the images.

10. The microscope control arrangement according to claim 1, wherein the one or more processors are configured to process fluorophore information indicating one or more fluorophores, and to derive control parameters for controlling at least an illumination intensity in each of the plurality of microscopy operation modes.

11. The microscope control arrangement according to claim 10, wherein
the graphical user interface further includes one or more fluorophore widgets corresponding to the one or more fluorophores indicated by the fluorophore information, and
each of the fluorophore widgets comprises a first widget zone and a second widget zone, the first widget zone providing a user feedback relating to the corresponding fluorophore and the second widget zone indicating the illumination intensity.

12. The microscope control arrangement according to claim 10, wherein in each of the fluorophore widgets, the second widget zone is rendered as a rim surrounding the first widget zone, a proportion of the rim being rendered differently from a remaining proportion of the rim in correspondence to the illumination intensity.

13. A microscope system comprising a fluorescence microscope and a microscope control arrangement according to claim 1.

14. A method for controlling a microscope, the method comprising:
rendering a graphical user interface, the graphical user interface including control widgets configured to receive user inputs, and
translating the user inputs to the control widgets into at least one of an illumination setting or a detection setting in dependence of a microscopy operation mode selected from a plurality of microscopy operation modes.

15. (canceled)

16. A non-transitory computer-readable medium with program code stored thereon, the program code, when executed by one or more computer processors, causing performance of the method according to claim 14.
